(19) United States
(12) Patent Application Publication
(10) Pub. No.: US 2013/0112743 A1
(43) Pub. Date: May 9, 2013

(54) DEVICE TO ANALYZE POINT OF SALE PRINT STREAM AND ENCODE TRANSACTION DATA

(71) Applicants: Rob Cavin, San Francisco, CA (US); Jeffrey Vick, San Francisco, CA (US)

(72) Inventors: Rob Cavin, San Francisco, CA (US); Jeffrey Vick, San Francisco, CA (US)

(21) Appl. No.: 13/607,764

(22) Filed: Sep. 9, 2012

Related U.S. Application Data
(60) Provisional application No. 61/534,003, filed on Sep. 13, 2011.

(51) Int. Cl. G06Q 30/04

(52) U.S. Cl. 235/375

(57) ABSTRACT

A method and apparatus to implement an improved point of sale system. When a transaction takes place, the apparatus analyzes the incoming receipt printer stream and outputs a modified receipt printer stream which includes a QR code which encodes information (such as transaction number, items purchased, price, etc.) about the transaction. The information can be retrieved in numerous ways. For example, a smartphone can scan the QR code to determine the information. Alternatively, the information can be uploaded to a remote server and a smartphone application an use the QR code to determine a code that can be used to retrieve the information from the remote server.

### CROSS REFERENCE TO RELATED APPLICATIONS

This application claims benefit to U.S. provisional application 61/534,003, filed on Sep. 13, 2011, entitled, “DEVICE TO ANALYZE POINT OF SALE PRINT STREAM AND ENCODE TRANSACTION DATA” which is incorporated by reference herein in its entirety.

### BACKGROUND OF THE INVENTION

1. Field of the Invention

The present inventive concept buffers information from the normal print stream output of a Point of Sale (POS) system terminal, analyzes the transactional data, and then sends an altered data stream to a printer, local terminal, or remote server. In some cases this device may communicate directly with a client device, typically a smartphone, using short-distance wireless technologies.

2. Description of the Related Art

Many large businesses employ technology to link customer information to individual transactions or visits to a business, for purposes including loyalty and reward programs, customer feedback, and targeted marketing. These methods include loyalty cards with an identifying number encoded via a magnetic stripe, systems based on a manual phone number entry, and more recently cards and smartphones using NFC technologies. However these systems are too complex for a large percentage of businesses to implement and manage. This complexity stems from software modification of their point of sale system and expensive new hardware additions.

Software solutions to capture transactional data are costly. There are a large number of POS software platforms, requiring unique solutions for each platform if detailed transaction information is required. Even with the simplest software solution, the typical business owner does not have the expertise to upgrade the software on their installed terminals, thus requiring expensive and time consuming installation.

There are also many types of hardware platforms. In a large percentage of cases, the POS includes a separate receipt printer. The data stream between the POS system and the printer is the most standardized part of the POS platform. Because receipts are often printed that include transactional data, an interposer in the print stream can capture these details. A few hardware solutions have been proposed. These proposed solutions rely on local memory to store information about customers and transactions.

### SUMMARY OF THE INVENTION

It is an aspect of the present invention to provide an improved point of sale system

The above aspects can be obtained by an apparatus that includes (a) a printer input interface configured to receive a receipt printer stream defining an original receipt; (b) a printer output interface configured to output a modified printer stream defining a modified receipt; (c) a processing unit configured to (i) analyze the receipt printer stream; (ii) extract information from the receipt printer stream; and (iii) generate the modified printer stream which comprises a QR code which encodes the information.

The above aspects can also be obtained by an apparatus that includes (a) a printer input interface configured to receive a receipt printer stream defining an original receipt; (b) a printer output interface configured to output a modified printer stream defining a modified receipt; (c) a processing unit configured to: (i) analyze the receipt printer stream; (ii) extract information from the receipt printer stream; (iii) cause an uploading of the information to a server; and (iv) generate the modified printer stream which comprises a QR code which encodes a code which identifies the information on the server for retrieval.

The above aspects can also be obtained by a method that includes (a) performing on an electronic device: (b) receiving a receipt printer stream; (c) analyzing the receipt printer stream; (d) extracting information from the receipt printer stream; (e) generating a QR code identifying the information; (f) outputting a modified printer stream comprising data for the QR code which causes a receipt to print which includes the QR code; (g) providing a smartphone application configured to scan the QR code and identify the information from the QR code.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a block diagram illustrating a point of sale system which prints a QR code on the receipt, according to an embodiment;

FIG. 2 is a block diagram illustrating a point of sale system which displays a QR code on an output display, according to an embodiment;

FIG. 3 is a block diagram illustrating a point of sale system in which a code is broadcast, according to an embodiment; and

FIG. 4 is a block diagram illustrating a point of sale system which utilizes location information, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The inventive concept described herein improves on past designs by making the interposer device stateless. The inventive concept does not capture any information. Instead it alters the print stream, adding a special code, before it is routed to another device. A customer then interacts with the code using his or her own internet enabled device, often a smart-phone, to complete the transaction.

A typical POS system includes a computer or terminal running POS software connected to a separate receipt printer. The device/apparatus described herein connects to the POS system using any printer interface, including but not limited to serial, parallel, USB, Ethernet, and wireless interfaces. In all embodiments the invention includes a programmable device, typically a microcontroller including a program and a data buffer. The device is programmed to buffer and analyze the incoming data stream. The device also mimics or forwards flow control and initialization information to the POS terminal. In many embodiments, the device will communicate with the POS terminal as a standard POS peripheral, most commonly a printer, to limit the need for specific software drivers. In other embodiments, the device may appear as a new peripheral with new drivers required.

The programmable device buffers and analyzes the incoming data stream, extracting key information about the transaction. In some embodiments, this information may be uploaded to a remote server via a wired or wireless connection. This server may be located at the business using the invention, at a remote site, or may be a “virtual server” in a cloud-based hosting system. Note that in these embodiments, in contrast to prior art, the uploaded information is not yet linked to a specific customer.

Details of the transaction, including but not limited to store name, POS terminal operator, time, price, items purchased, transaction number, etc., are encoded in some manner. Typically the encoding will include a unique identifier for the specific transaction to ensure uniqueness of the encoded data. This encoded data is appended to, used to modify, or replaces the original data stream. The resultant data stream is sent to one or more terminals or peripherals depending on the embodiment of the invention. The invention need not retain any history of the transaction once the encoded data is forwarded to the local peripheral. Thus in one embodiment, the invention may be said to be “stateless”. In another embodiment, the device may retain non-volatile state to allow configuration for a specific environment. In the same or other embodiments, the device may update an internal counter state element after each transaction to create a unique transaction id.

In all embodiments, a customer interacts with the encoded data, typically represented as a QR code or short alphanumeric text code, using an internet enabled device or a device that may later send data to and receive data from the internet directly or via an intermediary device. When the customer's device does connect with the internet, details of their interactions with one or more codes is used to link the specific customer to the transaction represented by said code.

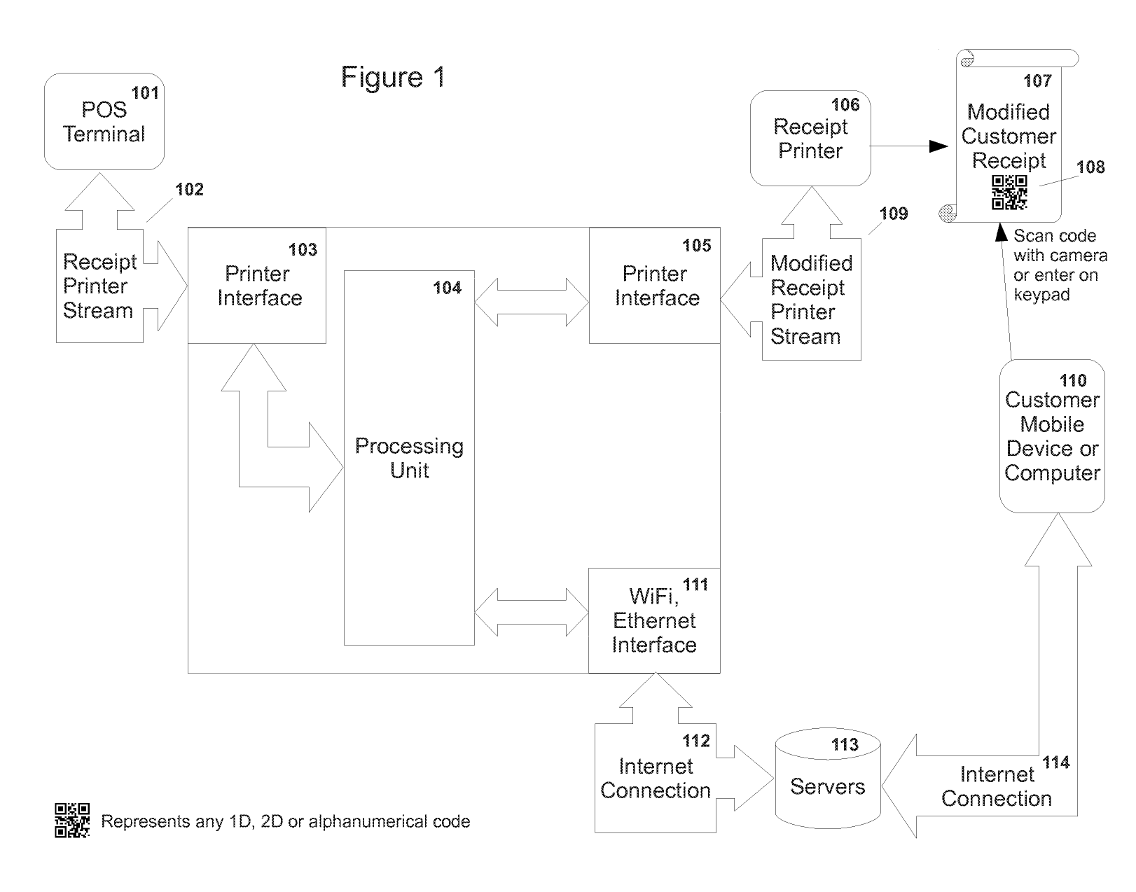

FIG. 1 is a block diagram illustrating a point of sale system which prints a QR code on the receipt, according to an embodiment. A printer output interface 105 may be connected to a printer 106, in which case the data stream 102 is modified 109 to include a special code 108, typically a 2D Quick Response (QR) code. In one implementation, the code is unique and encodes information about the specific transaction that was just streamed through the invention. In the same or other implementations, the code may include details related to the specific store, terminal, or operator. The original data in the print stream may or may not appear in the printer output/modified customer receipt 107. A printer interface 103 (also referred to as printer input interface) connects the receipt printer stream 102 with the processing unit 104. The processing unit can also be connected to a Wi-Fi Ethernet interface 111 which is connected to an Internet connection 112.

The information encoded may include data from the original print stream, or a code to reference the details of the transaction that have been uploaded to a remote server 113 by the device or POS system 101. In this implementation of the invention, the link between the specific transactional details and a specific customer is made when the customer interacts with a remote server 113 using the special code 108. In one implementation, this will be accomplished by scanning the 2D QR code using a smartphone device 110. In the same or another implementation, the output may include the same or different character string code, which the customer may enter manually into a special application or web site. The server 113 communicates with customer mobile device 110 or computer via internet connection 114.

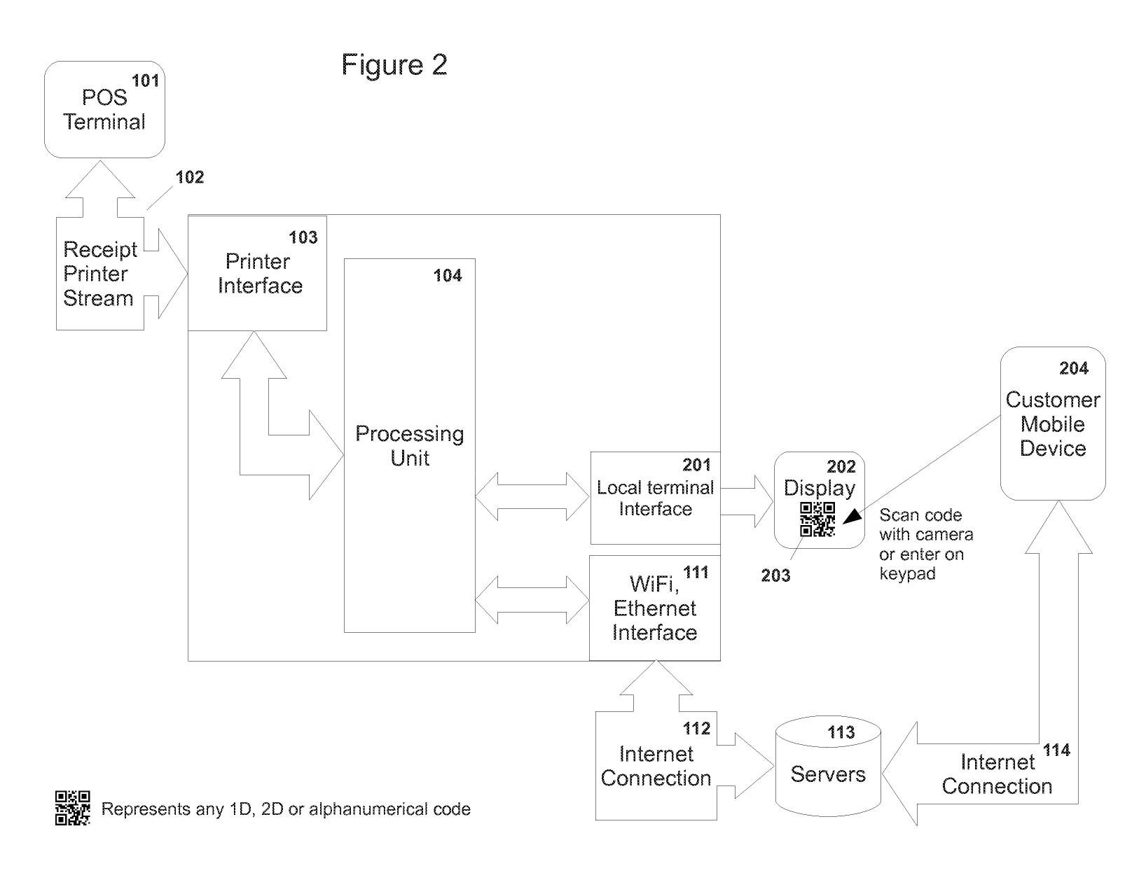

FIG. 2 is a block diagram illustrating a point of sale system which displays a QR code on an output display, according to an embodiment. The local terminal interface 201 sends output which may be connected to a local display (or terminal) 202 which may or may not support user input, such as a monitor, small LCD screen, tablet, smartphone, or other portable devices. In this embodiment the data stream 102 is modified to include a special code 203, typically a 2D Quick Response (QR) code. In one implementation, the code is unique and encodes information about the specific transaction that was just streamed through the invention. In the same or other implementations, the code may include details related to the specific store, terminal, or operator. The original data in the print stream may or may not appear in the terminal output.

The information encoded may include data from the original print stream, or a code to reference the details of the transaction that have been uploaded to a remote server 113 by the device or POS system 101. In this implementation of the invention, the link between the specific transactional details and a specific customer is made when the customer interacts with a remote server 113 using the special code 203. In one implementation, this will be accomplished by scanning the 2D QR code using a smartphone device 204.

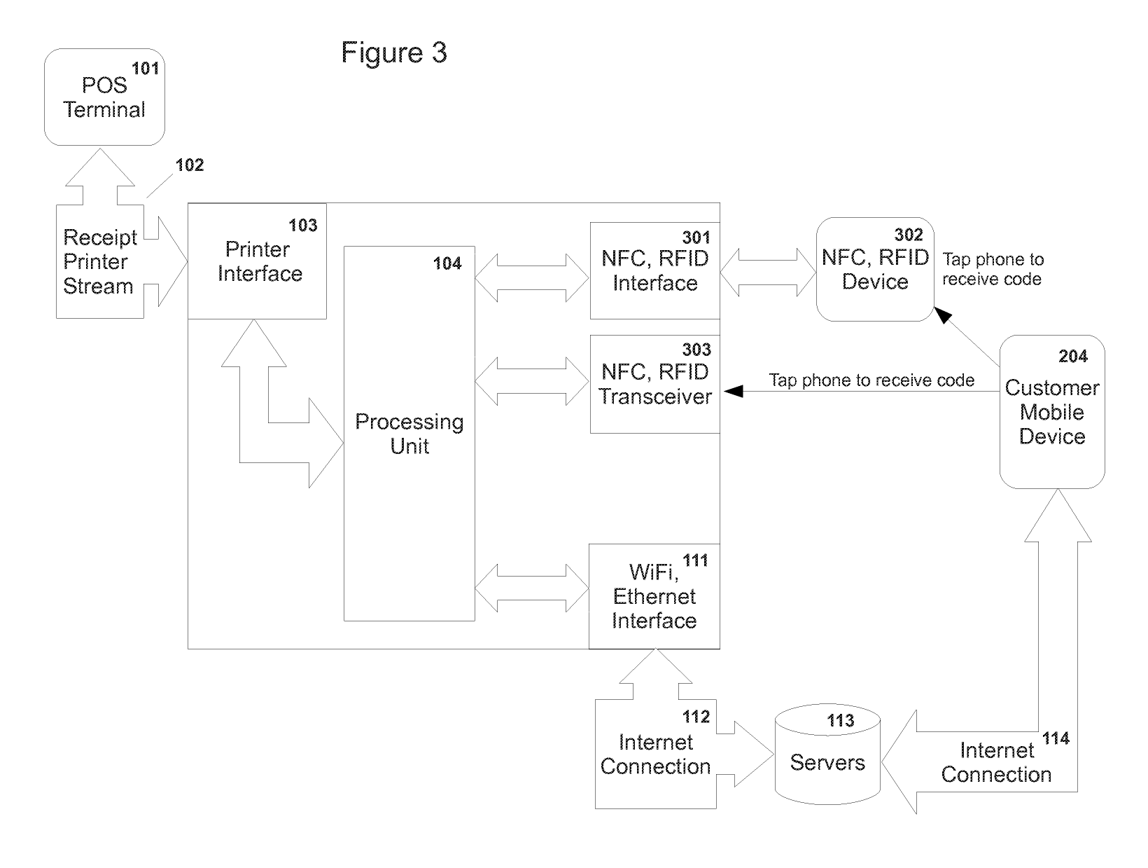

FIG. 3 is a block diagram illustrating a point of sale system in which a code is broadcast, according to an embodiment. The output may be sent to an RFID or NFC enabled device 302, or be broadcast via an internal RFID or NFC transceiver 303, in which case the input data stream is typically dropped and the encoded details of the transaction sent to the device/transceiver. In one implementation, the code is unique and encodes information about the specific transaction that was just streamed through the invention. In the same or other implementations, the code may include details related to the specific store, terminal, or operator.

In this implementation of the invention, the link between the specific transactional details and a specific customer is made when the customer interacts with a remote server 113 using the special code. In one implementation, this will be accomplished by touching the RFID/NFC device (whether a separate local device or integrated with the invention) with the customer's RFID/NFC device 302. This device will typically be of the type with immediate internet connectivity, such as a smartphone 204. Alternatively this device may record the transaction offline and later synchronize to the internet, using its own internet connection or a proxy device. The processing unit 104 is connected to a NFC/RFID interface 301 which communicates with the NFC/RFID device 302.

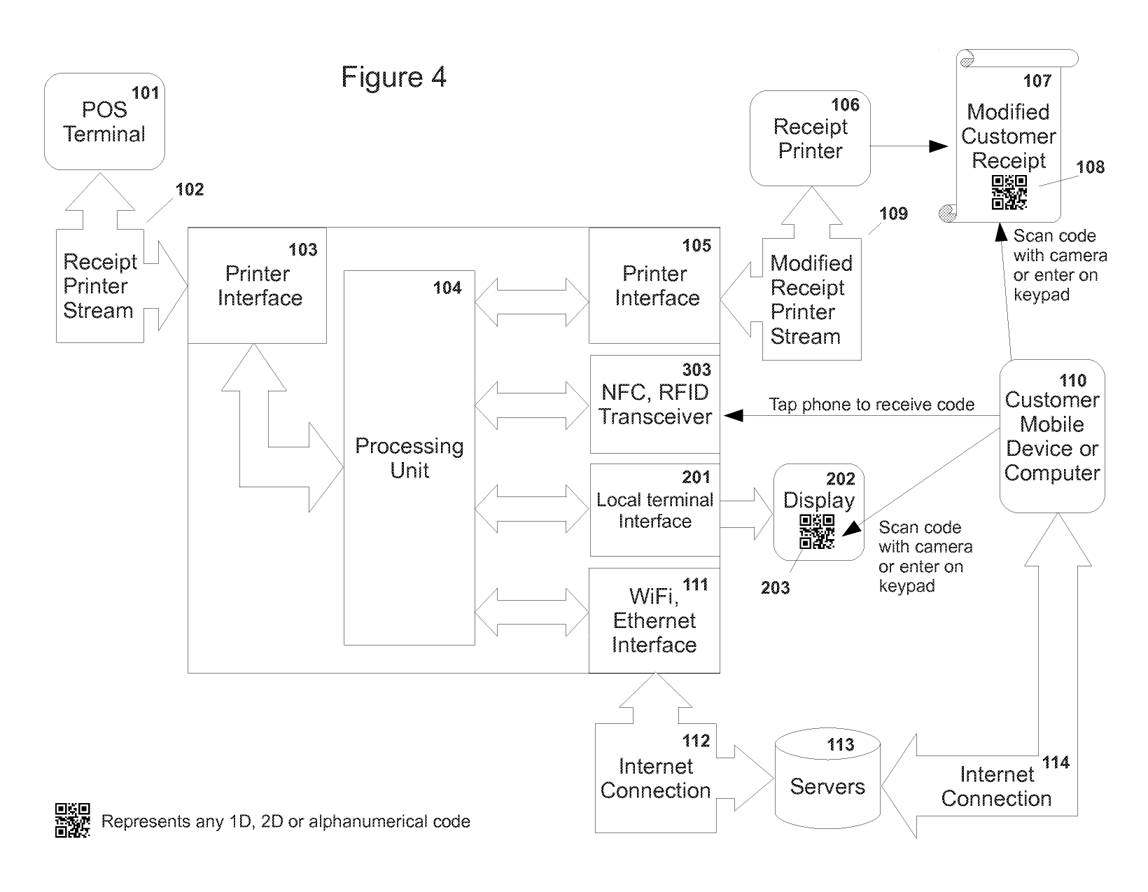

FIG. 4 is a block diagram illustrating a point of sale system which utilizes location information, according to an embodiment. The details of the transaction are uploaded to a remote server 113, along with the location of the business where the invention is being used. This location may be an address, latitude/longitude pair, or any other means of specifying a geographic location. The invention also creates a short code 108, typically a character string. This code is typically output to a printer 106, either inserted into or replacing the original print stream 107.

The customer using a smartphone device 204 interacts with a remote server 113 or group of servers, providing both location information and the code 108. This data set pair is used to uniquely tie the customer to the specific transaction.

In another embodiment of the invention depicted in FIG. 4, two or more of the above embodiments may be combined to provide multiple options for customer interaction.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus, comprising:
a printer input interface configured to receive a receipt printer stream defining an original receipt;
a printer output interface configured to output a modified printer stream defining a modified receipt;
a processing unit configured to:
a) analyze the receipt printer stream;
b) extract information from the receipt printer stream; and
c) generate the modified printer stream which comprises a QR code which encodes the information.

2. The apparatus as recited in claim 1, wherein the information comprises price.

3. The apparatus as recited in claim 1, wherein the information comprises items purchased.

4. The apparatus as recited in claim 1, wherein the information comprises a transaction number.

5. The apparatus as recited in claim 1, wherein the processing unit is further configured to upload the information to a remote server using the Internet.

6. The apparatus as recited in claim 5, wherein the QR comprises a code identifying the information on the remove server for retrieval of the information.

7. The apparatus as recited in claim 6, further comprising a smartphone application configured to scan the QR code to determine the code and retrieve the information from the server using the code.

8. The apparatus as recited in claim 5, wherein the information comprises data identifying a geographic location of where the apparatus is located.

9. The apparatus as recited in claim 1, wherein the printer input interface is connected to a point of sale terminal.

10. The apparatus as recited in claim 1, wherein the printer output interface is connected to a receipt printer and the modified printer stream is configured such that the QR code prints on a receipt printed on the receipt printer.

11. The apparatus as recited in claim 9, wherein the printer output interface is connected to a receipt printer and the modified printer stream is configured such that the QR code prints on a receipt printed on the receipt printer.

12. The apparatus as recited in claim 1, wherein the printer output interface is connected to an electronic display and the modified printer stream is configured to display the QR code on the electronic output display.

13. The apparatus as recited in claim 9, wherein the printer output interface is connected to an electronic display and the modified printer stream is configured to display the QR code on the electronic output display.

14. An apparatus, comprising:
a printer input interface configured to receive a receipt printer stream defining an original receipt;
a printer output interface configured to output a modified printer stream defining a modified receipt;
a processing unit configured to:
a) analyze the receipt printer stream;
b) extract information from the receipt printer stream;
c) cause an uploading of the information to a server; and
d) generate the modified printer stream which comprises a QR code which encodes a code which identifies the information on the server for retrieval.

15. The apparatus as recited in claim 14, wherein the printer input interface is connected to a point of sale terminal.

16. The apparatus as recited in claim 14, wherein the printer output interface is connected to a receipt printer and the modified printer stream is configured such that the QR code prints on a receipt printed on the receipt printer.

17. The apparatus as recited in claim 14, further comprising a web site configured to retrieve the information when the code is received.

18. A method, comprising:
performing on an electronic device:
receiving a receipt printer stream;
analyzing the receipt printer stream;
extracting information from the receipt printer stream;
generating a QR code identifying the information;
outputting a modified printer stream comprising data for the QR code which causes a receipt to print which includes the QR code;
providing a smartphone application configured to scan the QR code and identify the information from the QR code.

19. The method as recited in claim 18, wherein the information is encoded in the QR code and the smartphone application determines the information directly from the QR code.

20. The method as recited in claim 18, wherein the device uploads the information to a remote server and the smartphone application uses a code encoded in the QR code to retrieve the information from the remote server.
